(19) United States
(12) Patent Application Publication
(10) Pub. No.: US 2015/0322957 A1
(43) Pub. Date: Nov. 12, 2015

(54) COMBINED RADIAL AND THRUST BEARING AND WET ROTOR PUMP

(71) Applicant: YASA MOTORS POLAND SP. Z.O.O., Mielec (PL)

(72) Inventor: Markus MÜLLER, Münnerstadt (DE)

(73) Assignee: YASA MOTORS POLAND SP. Z O.O., Mielec (PL)

(21) Appl. No.: 14/761,666

(22) PCT Filed: Jan. 16, 2014
(86) PCT No.: PCT/EP2014/050747

§ 371 Date: Jul. 17, 2015

(30) Foreign Application Priority Data
Jan. 17, 2013 (DE) 10 2013 200 655.1

(51) Int. Cl. F04D 29/041; F04D 3/00; F04D 19/00; F04D 29/059; F04D 25/02; F04D 29/051; F04D 29/049; F16C 19/54; F04D 13/02

(52) U.S. Cl. CPC F04D 29/0413; F16C 19/545; F04D 3/005; F04D 19/002; F04D 13/02; F04D 25/02; F04D 29/0513; F04D 29/049; F04D 29/059

(57) ABSTRACT

A device having a first and a second component, wherein the second component includes an opening, wherein the first component is mounted such that the first component can rotate in the radial direction and on one side in the axial direction in the opening of the second component about an axis of the first component, wherein the device is formed in such a manner that a fluid can flow in the axial direction through the opening of the second component, wherein the device also comprises at least two bearing shells, and rolling bodies, wherein a first of the bearing shells is fastened to or axially supported on the first component and a second of the bearing shells is fastened to or axially supported on the second component, wherein the rolling bodies are situated in the space circumscribed by the running faces of the two bearing shells, as a result of which a rolling bearing that can be loaded in the axial direction on one side is formed for axially bearing the first component in the second component, and wherein a sliding bearing for radially bearing the first component on the second component is formed by a cylindrical surface of the first component and an inner lateral surface of the second bearing shell and/or by an in particular cylindrical surface of the opening of the second component and an outer lateral surface of the first bearing shell.

### PRIORITY CLAIM

This application claims benefit of foreign priority in accordance with 35 U.S.C. 119(b) to German application No. 10 2013 200 655.1 filed on Jan. 17, 2013.

### BACKGROUND

The disclosure relates to a combined radial and thrust bearing through which a fluid can flow.

Combined thrust and radial bearings, especially for casters of movable objects, support rollers for conveyors or similar devices, with a first bearing ring that is both axially and radially supported on a second bearing ring are disclosed in DE 22 64 912 A1, for example. Another combined thrust and radial bearing is disclosed in the official publication DE 196 31 437 A1. In particular, these publications disclose a combination of a bearing race and a sliding bearing. In addition, the bore hole in the housing has a supporting ring against which the bearing race is supported in one axial direction and a sliding bearing flanged sleeve arranged on the shaft is supported in the opposite axial direction and in the radial direction.

### BRIEF DESCRIPTION OF THE DRAWINGS

Embodiments of the disclosure will be explained in detail below with reference to the drawings. The figures are as follows:

FIG. 1 shows a sectional view of an inventive device.

FIG. 2 shows a sectional view of the device from FIG. 1 with a filter element.

FIG. 3 shows a sectional view of an inventive wet rotor pump.

FIG. 4a shows a sectional view of an embodiment of the separating can.

FIG. 4b shows a top view of the separating can shown in FIG. 4a.

FIG. 5a shows a side view of an individual stator tooth.

FIG. 5b shows a front view of the stator tooth shown in FIG. 5a.

FIG. 5c shows a perspective view of the stator tooth shown in FIG. 5a.

FIG. 6a shows a top view of an embodiment of the stator.

FIG. 6b shows a sectional view of the stator shown in FIG. 6a.

FIG. 7a shows a top view of an embodiment of the rotor.

FIG. 7b shows a sectional view of the rotor shown in FIG. 7a.

FIG. 8 shows a sectional view of another inventive wet rotor pump.

### DESCRIPTION

The disclosure is based on the goal of creating an improved combined thrust and radial bearing.

The goal of the disclosure is achieved by the features of claim 1. Embodiments of the disclosure are specified in the dependent claims.

The disclosure relates to a device with a first and a second component, the first component being mounted in an opening of the second component, and a fluid being able to flow through the opening of the second component.

According to one embodiment of the disclosure, the first component is mounted in the opening of the second component in such a way that it can rotate about an axis of the first component in the radial direction and on one side in the axial direction. In addition to the first and second components, the device also comprises at least two bearing shells and rolling bodies. These bearing shells are shaped in such a way that they have running surfaces, which can hold the rolling bodies and in which the rolling bodies can roll with as little friction as possible. A first bearing shell is axially supported on the first component and a second bearing shell is supported on the second component. The rolling bodies are located in the space delimited by the running surfaces of the two bearing shells. This arrangement of bearing shells and rolling bodies forms a rolling bearing that can bear a load on one side in the axial direction for axial support of the first component in the second component. Simultaneously, a surface of the first component, especially a cylindrical surface, and a lateral surface of the second bearing shell and/or a cylindrical surface of the opening of the second component and an outer lateral surface of the first bearing shell form a sliding bearing for radial support of the first component on the second component.

Embodiments of the in disclosure are especially advantageous since the bearing shells of the rolling bearing also serve as a sliding surface of a sliding bearing, and thus have a double function. Thus, this is a very compact radial and thrust bearing that can be used especially for applications in which it is important for the design to be as compact as possible or for the overall height to be as small as possible. Simultaneously, a fluid can flow through the combination of components and bearings, so that the previously mentioned devices have a wide range of applications. This fluid can be a gas or a liquid.

According to one embodiment of the disclosure, the first and/or second bearing shell can be radially displaced with respect to the axially supporting component in an oversized [hole], to follow an off-center position of the sliding bearing, thus maintaining the coaxial orientation of the bearing shells to one another.

This “floating” arrangement of the drill hole side bearing shell can, in turn, be realized in an especially advantageous manner with commonly used standard thrust bearings. As explained, it is expedient for the drill hole forming the sliding bearing with the shaft-side bearing shell to be slightly oversized. If, in addition, the drill hole maintains a cylindrical shape, in operation the drill hole-side bearing shell in it can radially align itself toward the shaft-side bearing shell serving as sliding bearing journal. This can compensate an off-center position of the bearing shell, with the result that the rolling bodies have an optimal central course in the grooves of the bearing shells. An off-center position can arise, for example, because of a radial load in one direction that narrows the sliding bearing gap on one side because of hydrodynamic effects.

According to one embodiment of the disclosure, the fluid can penetrate into at least one of the sliding bearings and/or the rolling bearing.

Embodiments of the disclosure are especially advantageous when the fluid is a liquid that is suitable as a lubricant and/or coolant. In this case, the moving parts of the bearings are additionally lubricated or cooled by the fluid, reducing bearing wear.

According to one embodiment of the disclosure, the device also comprises a particle filter that is arranged on a side of the bearing shells facing away from the running surfaces of the rolling bearings. The particle filter can especially be in the form of a fine wire filter.

Embodiments of the disclosure are especially advantageous if the fluid entrains particles that could damage the bearing, for example sand or metal shavings. In this case, the particle filter removes the particles from the fluid before it gets into the moving parts of the bearings, so that it can serve as a lubricant in the moving parts of the bearings, without it being necessary to fear damage to the bearing surfaces.

According to one embodiment of the disclosure, the running surfaces and/or lateral surface of the bearing shells and/or the rolling bodies are coated with silicon carbide (SiC) and/or diamond-like carbon (DLC) and/or silicon-containing DLC. These coatings increase the durability of the bearing by improving the rolling and sliding properties of the surfaces of the moving parts of the bearings.

According to one embodiment of the disclosure, the rolling bodies are spheres that are connected together by a cage. This is especially advantageous when the device is intended to be used for high rotational speeds of the first component with respect to the second component, for example in a turbine arrangement.

According to another embodiment of the disclosure, the first component is axially supported in the opening of the second component by a magnetic bearing, instead of the previously described rolling bearing. To accomplish this, at least two magnetic rings are used, a first magnetic ring being axially supported on the first component and a second magnetic ring being axially supported on the second component. The magnetization of the magnetic rings is arranged so that they repel one another in the axial direction. The repulsive force between the magnetic rings generally increases as the distance between the rings decreases, so that the axial position of the first component with respect to the second component is variable within a certain range. Analogous to the previously described device with a rolling bearing, the first component is radially supported in the second component by one or more radial sliding bearings. This can form a sliding bearing between a surface of the first component, especially a cylindrical surface, and a lateral surface of the second magnetic ring and/or a surface of the opening of the second component, especially a cylindrical surface, and an outer lateral surface of the first magnetic ring.

Embodiments are especially advantageous, since as long as the contact pressure of the first component on the second component is not too large, the bearing is completely frictionless in the axial direction. Therefore, on the one hand the wear of the thrust bearing is very small, and on the other hand the device can contribute to high efficiency if it is used in machines, for example, since the machine's friction losses due to the bearing are kept very small.

According to one embodiment of the disclosure, at least part of the fluid can get into parts of the bearing, sliding bearing, and/or magnetic bearing, which is especially advantageous when the fluid is suitable as a coolant or lubricant. This can make it necessary to encapsulate the magnetic rings, if there is a danger that the fluid will affect the magnetic material's properties. In so doing, it is especially advantageous if the magnetic rings are coated with a soft magnetic material on the side facing one another to strengthen the magnetic flux in this area. Simultaneously, the other parts can be encapsulated by a non-magnetic material such as stainless steel, for example. A sealing connection between the soft magnetic material, on the one hand, and the non-magnetic material, on the other hand, can be produced by laser beam welding or friction welding of the two parts, for example.

Analogous to the preceding description, according to one embodiment of the disclosure it is advantageous to [protect] the bearing by a particle filter, especially a fine wire filter, to prevent particles, which can be entrained in the fluid, from getting into the bearing. This can prevent damage or even destruction of the bearing. The particle filter should be arranged so that it filters the fluid before it can get into the bearing; its arrangement depends on the direction of flow of the fluid through the device.

According to one embodiment of the disclosure, the lateral surfaces of the magnetic rings are coated with silicon carbide (SiC) and/or diamond like carbon (DLC) and/or silicon-containing DLC, which improves their sliding properties and further increases the durability of the bearing.

According to one embodiment of the disclosure, the first component comprises an opening, so that the fluid can flow through the opening of the first component. Thus, a fluid can flow through the combination of the first component, second component, and bearing.

According to one embodiment of the disclosure, the radial bearing clearance is adapted in such a way that the sliding bearing is a fluid bearing. This is especially advantageous, since for the most part fluid bearings have fluid friction, especially at high rotational speeds, and thus the durability of the sliding bearing is further increased.

According to one embodiment of the disclosure, the device is a turbine, the first component being an arrangement of blade wheels. The second component can be a part of the turbine housing, for example. In this embodiment, a fluid, such as, for example, water or air, can be forced through the first component under pressure, exerting a torque on the arrangement of blade wheels. The first component, which is caused to rotate, can in turn drive a generator for power generation, for example. It is also possible for the first component to be driven by a motor. In this case, the turbine arrangement can suck a fluid through it, which exerts a force on the device that is opposite the fluid's direction of flow.

According to one embodiment of the disclosure, the device is the rotary transmission leadthrough of a machine tool. Here the term machine tool is understood to mean a machine that causes a machining head to rotate by means of a driven spindle. The driven rotation of the machining head makes it possible to machine an object. For example, the machine tool can be a boring or milling machine. Here the spindle represents the first component of the device. The inside width in the spindle mount makes it is possible, for example, to supply the machining head with lubricant or coolant during operation.

According to one embodiment of the disclosure, the device is a dental turbine. In this embodiment, the first component has an arrangement of blade wheels and is supported in a part of the turbine housing, for example. If a fluid, such as, for example, air is now forced through the device, this applies a torque to the component. If the first component is further connected with a machining head, such as, for example, a dental drill, it makes the latter rotate. The bearing's low friction, especially in the case of the embodiment with a magnetic bearing, allows the drill head to achieve very high rotational speeds without developing much noise.

Another aspect of the disclosure relates to a wet rotor pump to deliver a fluid, especially a liquid, using the previously described bearing. A wet rotor pump per se is disclosed in WO 00/37804, for example.

According to embodiments of the disclosure, the wet rotor pump has a stator and a separating can in a dry area and a rotor that is connected with an impeller and that is arranged in a wet area. An intake pipe to let in the fluid to be delivered through the wet rotor pump runs axially through the stator and the separating can, and opens into the wet area. At the end of the intake pipe that opens into the wet area there is an impeller bearing through which the fluid flows when the wet rotor pump is in operation. The bearing is designed as a combined thrust and radial bearing in accordance with the preceding discussion, to mount the impeller radially and on one side axially, countering the magnetic attraction exerted on the impeller by the stator.

The arrangement of the bearing on the end of the intake pipe and the structural design of the bearing as a combined thrust and radial bearing allows the wet rotor pump to be especially compact, in particular to have an especially small overall height, and allows the bearing to have an especially long life, since the fluid flowing through the bearing can reduce the wear of the bearing.

Embodiments of the disclosure create a wet rotor pump in which an intake pipe for the fluid runs through the stator, the separating can, and the bearing for the impeller. Such geometry is allowed by making the motor as an axial-flow motor, and has the special advantage of allowing the wet rotor pump to be especially compact, that is, to have a small overall height, in combination with high power density.

Embodiments of the disclosure are also especially advantageous since the bearing simultaneously acts as a seal at the transition between the suction and pressure sides of the wet rotor pump. The relatively small distance between adjacent parts and the small tolerances of the bearing keeps leakage losses small. Furthermore, large forces can arise, especially in the axial direction, due to the attraction of the stator and rotor magnets, which could lead to high wear in a sliding bearing. By contrast, a rolling bearing is characterized by small friction, mainly in the form of rolling friction, while in a magnetic bearing the friction ideally completely disappears, so that the wear of the two bearing types is reduced from that in a sliding bearing.

According to one embodiment of the disclosure, the thrust bearing in accordance with the preceding discussion is formed by bearing shells that have running surfaces to hold rolling bodies, and rolling bodies. Here a first bearing shell is fastened to the impeller, while a second bearing shell is fastened to the separating can. The rolling bodies are located in the space delimited by the running surfaces of the bearing shells.

According to another embodiment of the disclosure, the thrust bearing in accordance with the preceding discussion is formed by magnetic rings, which have magnetization that makes the magnetic rings repel one another in the axial direction when they are mounted in the wet rotor pump. Here a first magnetic ring is fastened to the impeller and a second magnetic ring is fastened to the separating can.

Embodiments of the disclosure are especially advantageous, since the axial flow motor exerts a magnetic attraction on the impeller in the direction toward the stator, so that the impeller only needs to be mounted on one side. This simplifies the structure and further reduces the required overall height of the wet rotor pump.

According to one embodiment of the disclosure, the sliding bearing on the impeller side is formed by the outer lateral surface of the first bearing shell or of the first magnetic ring, and the lateral surface of the separating can. On the separating can side, the sliding bearing is formed by the inner lateral surface of the second bearing shell or of the second magnetic ring and the lateral surface of the impeller.

Embodiments are especially advantageous, since the bearing shells or magnetic rings on one side represent part of the sliding bearing, and on the other side they represent part of the thrust bearing. Thus, this is a hybrid bearing that represents a very compact and simultaneously long-lasting and robust bearing for a wet rotor pump.

To increase the durability of the bearing even more, one embodiment of the disclosure provides that the lateral surfaces and/or running surfaces of the bearing shells and/or the rolling bodies be coated with silicon carbide (SiC) and/or diamond-like carbon (DLC) and/or silicon-containing DLC.

According to another embodiment, the bearing is protected from the particles getting into it by a fine wire filter. This protects the bearing from damage caused by particles that could be entrained in the medium.

According to one embodiment of the disclosure, fluid intake is through a central opening in the separating can. In particular, the separating can can form an intake neck.

According to one embodiment of the disclosure, the stator is torus-shaped. In particular, the stator can have a ring-shaped stator tooth holder that has stator teeth arranged on it. The stator teeth can be fastened to the stator tooth holder by adhesive bonding, for example.

According to one embodiment of the disclosure, every stator tooth has an area to hold a coil. At the air gap end, every stator tooth has an enlarged cross section. This has the advantage that the magnetic field is approximately homogenous in a larger area within the air gap, and completely wraps around the rotor magnets that are narrower in the radial direction, supporting self centering of the impeller, in order to support self centering of the impeller. Here the term “air gap” is understood to mean the distance between the ends of the stator teeth and the rotor, even if what is in this gap is something other than air (e.g., fluid), or if it is air and something else.

According to one embodiment of the disclosure, the power electronics that drive the stator coils are arranged within the space delimited by the stator and the separating can, on a ring-shaped printed circuit board, for example. This can further reduce the overall height of the wet rotor pump.

According to one embodiment of the disclosure, the separating can is formed by a ring-shaped disc that projects into the air gap between the stator and the rotor and that separates the dry area of the wet rotor pump from the wet area. The ring-shaped disc has a central opening that has the intake neck arranged on it; this intake neck runs through the center of the stator. The bearing for the impeller is arranged on the disc-side end area of the intake neck; the fluid flows through this bearing into the wet area after it has flowed through the dry area in the intake pipe. The disc and the intake neck can be made as a single piece, especially as an injection-molded plastic part. In particular, the separating can can be made of plastic (e.g., polyphenylene sulfide/fiberglass/carbon-fiber-reinforced polymer) or of non-magnetic metal.

According to one embodiment of the disclosure, the rotor is made of a permanent magnetic material, namely samarium-cobalt (SmCo). This has several advantages:
Samarium-cobalt can be used at high temperatures without the remanence of magnetization suffering. Because of this, the fluid can have a temperature of up to 200° C., for example.
Samarium-cobalt possesses excellent corrosion properties and can be directly exposed to the fluid with simple corrosion protection, or without it.
Since samarium-cobalt does not require encapsulation (in stainless steel, for example) for corrosion protection, the magnetic material can be arranged at the outer edge of the periphery of the impeller or the drive wheel, so that the permanent magnetic material can be positioned with a maximum radius.

This permanent magnetic material forming the rotor can be in the form of several individual flat permanent magnets arranged on the periphery of the impeller or in the form of a single magnetic ring with multipolar magnetization. In particular, the magnets or magnetic ring can be fastened directly to the periphery of the impeller or be fastened to the impeller via a drive wheel.

In the following discussion of the embodiments, elements that correspond to one another or are identical are always labeled with the same reference numbers.

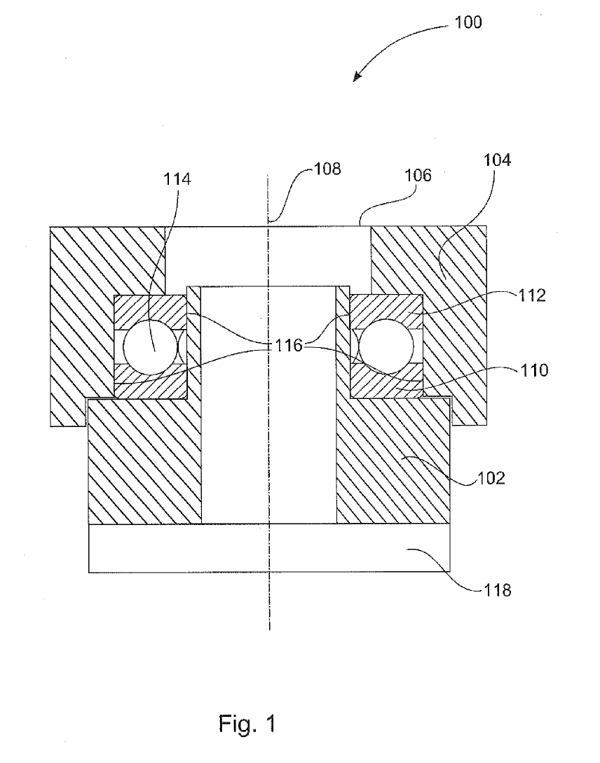

FIG. 1 shows an inventive device 100 with a first component 102 and a second component 104. The second component 104 has an opening 106, into which the first component 102 projects. Inside opening 106 there is a bearing for the first component 102, which consists of a first bearing shell 110, a second bearing shell 112, and a number of spherical rolling bodies 114, in the nature of a thrust ball bearing. The first bearing shell 110 is supported, at least axially, on the first component 102, while the second bearing shell 112 is supported, at least axially, on the second component 104. These axial supports lie opposite one another in the direction of the provided load, and surround the bearing that is provided in such a way as to hold it. Bearing shells 112 and 110 have running surfaces that are suitable to hold the rolling bodies 114. In particular, both running surfaces have grooves of the same type that guide the rolling bodies 114. One or both bearing shells 112 and 110 can, in addition to the mentioned axial support on components 102 or 104, also be radially or even completely fixed. Bearing shell 112 can be radially fixed by an exact fit between its outer lateral surface and the drill hole in the second component that holds it. Bearing shell 110 can be radially fixed by an exact fit between its inner lateral surface and the cylindrical extension on the first component 102. These parts can be fixed completely, i.e., against any movement, by adhesive bonding, bolting, or by shrinking or pressing them together, for example.

Rolling bodies 114 are located in the space delimited by the running surfaces of bearing shells 112 and 110, so that the combination of bearing shells 110 and 112 and rolling bodies 114 represents a rolling bearing that can be loaded in the axial direction on one side. This type of mounting allows the first component 102 to rotate about an axis 108 in component 104. In the embodiment shown in FIG. 1, axis 108 simultaneously represents the axis of symmetry of device 100. At the lower end of the first component 102 there is a transmission element 118.

The discussion below will assume that the first component 102 is acted on by a force in the direction of the second component 104, approximately along the axis 108. Such an axial force can arise, for example, by the magnetic attraction of a rotor-stator arrangement, or be produced by the weight force of the components. In device 100, the axial force is compensated by the axial rolling bearing consisting of bearing shells 110 and 112 and rolling bodies 114.

As shown in FIG. 1, first component 102 also has an opening through which a fluid can be conveyed. If transmission element 118 is designed as a drive, for example in the form of a turbine arrangement, then in the case that a fluid, for example air, flows upward through the combination of transmission element 118 and the first component, a torque is exerted on the first component 102. Mounting the first component 102 in the second component 104 by means of a rolling bearing allows component 102 to rotate with respect to component 104, the friction losses being kept small by the use of a rolling bearing. In addition to exerting a torque on first component 102, the flow of fluid through transmission element 118 exerts another force on first component 102, this one upward in the axial direction. Therefore, the previously described one-side axial mounting of the first component 102 in the second component 104 is sufficient.

In addition to axial forces and torques, radial forces can also arise due to the rotation of the first component 102, among other things. One cause of this can be, for example, imbalances in the first component 102, which can produce large radial forces, especially for applications with a high rotational speed, such as, for example, the previously mentioned turbine application. In the embodiment shown FIG. 1, these are compensated by sliding bearings, which are formed by sliding surfaces 116 between the first and second bearing shells and the first and second components. Thus, there is one sliding surface 116 between the outer lateral surface of the first bearing shell 110 and the inner lateral surface of the opening 106 in the second component 104, and another sliding surface 116 between the inner lateral surface of the second bearing shell 112 and the outer lateral surface of the first component 102.

Especially when standard or standardized axial rolling bearings with identical outside diameters are used on both bearing shells 110, 112, the described sliding bearing can be formed by the making the drill hole that holds them slightly oversized in the second component 104. If the drill hole that holds bearing shell 112 maintains a cylindrical shape, in operation the bearing shell 112, which is loose because of the oversize drill hole, can line up radially with the bearing shell 110 serving as a sliding bearing. This can compensate an off-center position of the bearing shell 110, with the result that the rolling bodies have an optimal central course in the grooves of the bearing shells 110, 112. An off-center position can arise, for example, because of a radial load in one direction that narrows the sliding bearing gap on one side because of hydrodynamic effects. If the bearing shell 112 is fixed exactly in the middle of the drill hole in the second component 104 that holds it, the off-center position of the sliding bearing would produce a radial load of the thrust bearing, with the known disadvantageous consequences for the contact pattern and the wear of the running surfaces of bearing shells 110, 112. Especially the thrust ball bearing schematically shown in the drawing is very sensitive to radial load and radial malposition, as is known. Because of the fixed predetermined grooves in the bearing shells, radial malposition results in a contact pattern that shows two opposite longer or shorter crescents, instead of a ring. In the worst case, this reduces the number of ball bearings effectively used to support the load to one or two. In any case, this results in unfavorable, irregular wear. In a serious case, rolling bodies and/or the running surfaces can already be damaged or destroyed even at a load below the prescribed limits.

To keep the friction within the sliding bearing as small as possible, the sliding surfaces 116 can be coated with silicon carbide (SiC) and/or diamond-like carbon (DLC) and/or silicon-containing DLC, for example. It is possible to coat the rolling bodies and running surfaces of the bearing shells in an analogous manner.

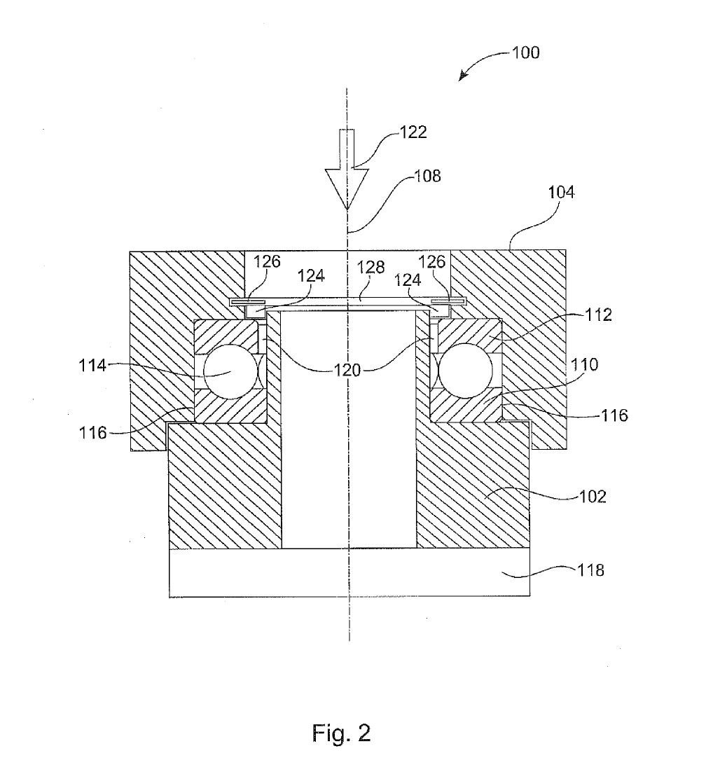

Like FIG. 1, FIG. 2 shows a device 100, wherein the flow direction 122 of the fluid through the device is from top to bottom, the opposite of that in the previous description. Such a flow direction 122 is present, for example, when the transmission element 118 represents a driven element, that is, designed in the form of an impeller, for example. In this case, the rotation of the first component 102 must be provided by an external drive, such as, for example, an axial flow motor (not net shown in FIG. 2).

In contrast to the device 100 shown in FIG. 1, there is a gap 120 between the second bearing shell 112 and the lateral surface of the first component 102, which is exaggerated in FIG. 2. This gap allows a fluid, which is conveyed by device 100, to enter the rolling bearing and sliding bearing. This is especially desirable when the fluid has properties that qualify it as a lubricant. To avoid the penetration of particles entrained with the fluid into the bearing, second bearing shell 112 has a filter element 124 located above it, which covers gap 120. Filter element 124 can be a fine wire filter, for example. This filter element 124 can filter all particles from the fluid that could cause intensified wear or even destruction of the bearing. Filter element 124 is fixed in position by a clamping ring 126 that is placed in a recess 128. As was already previously mentioned, gap 120 is exaggerated in FIG. 2.

In reality, the width of gap 120 should be in a range of about 50-100 μm. So, on the one hand the fluid can get into the bearing, while on the other hand the upper sliding bearing remains between the second bearing shell 112 and the lateral surface of the first component 102. Penetration of the fluid into the bearing makes it possible for fluid friction to appear in the sliding bearings, that is, for the sliding bearing to function as a hydrodynamic sliding bearing. This has the advantage that friction, and thus bearing wear, is further reduced.

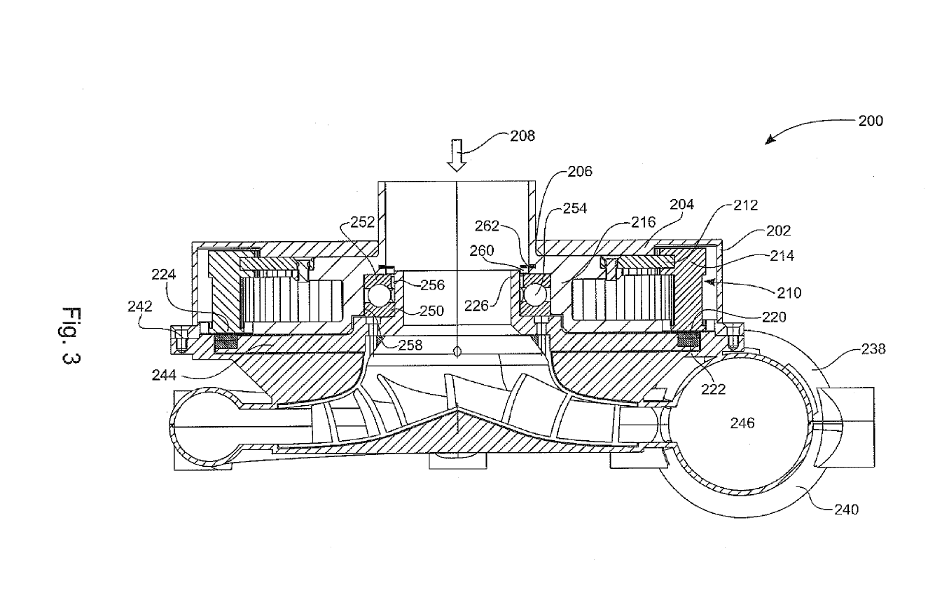

FIG. 3 shows a sectional view of an embodiment of an inventive wet rotor pump 200. Wet rotor pump 200 has a motor cover 202 with a circular face 204. Face 204 has an opening 206 in the center that is provided to allow a fluid 208 to flow in.

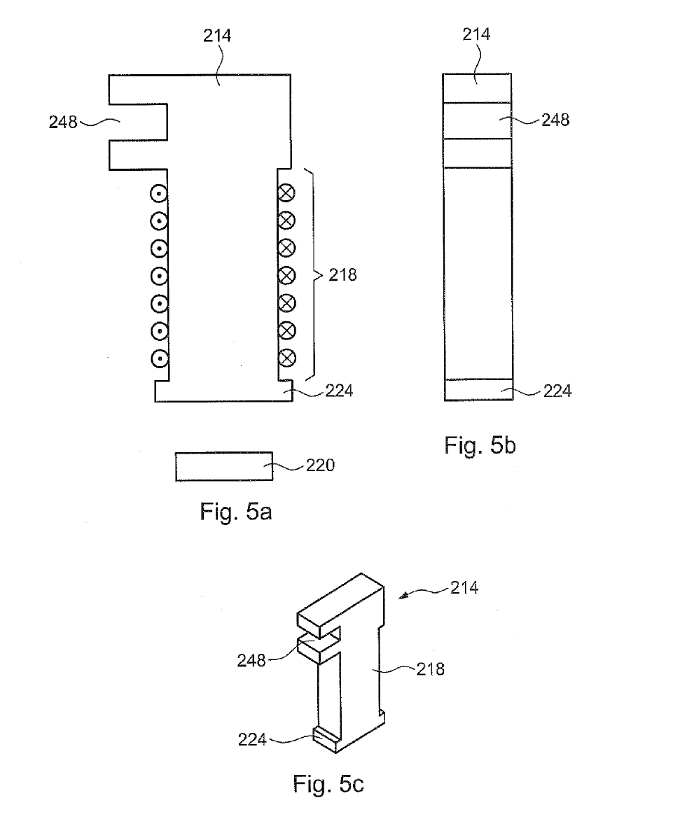

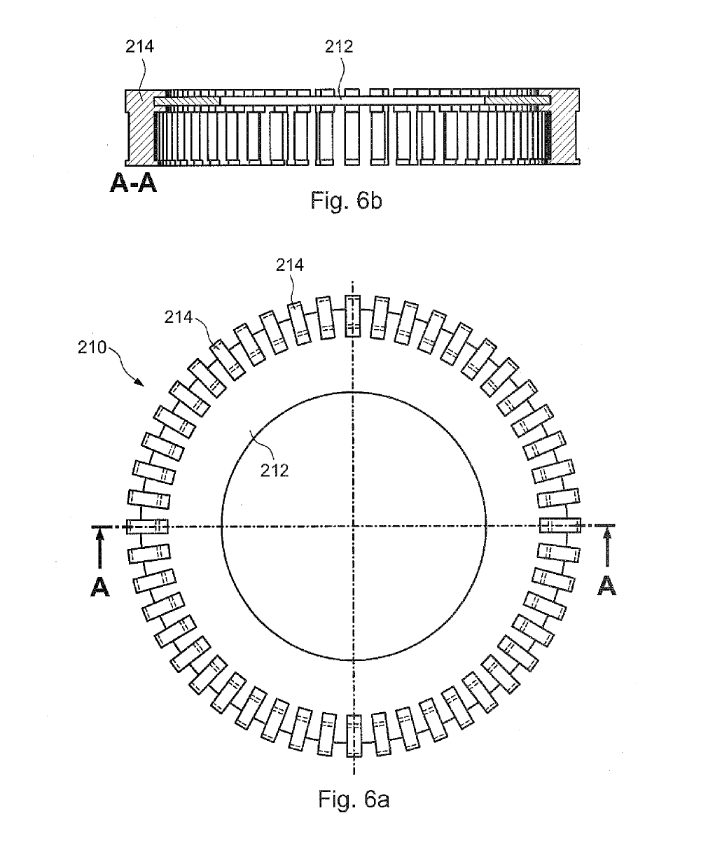

Motor cover 202 serves to cover a stator 210. Stator 210 has a ring-shaped stator tooth holder 212 that has stator teeth 214 arranged in a circle on it. Each stator tooth has a coil wound on it. The stator and stator teeth 214 will be explained in detail with reference to FIGS. 5 and 6.

The various coils of the stator teeth 214 are electrically connected with power electronics (not shown) that serve to control the coils.

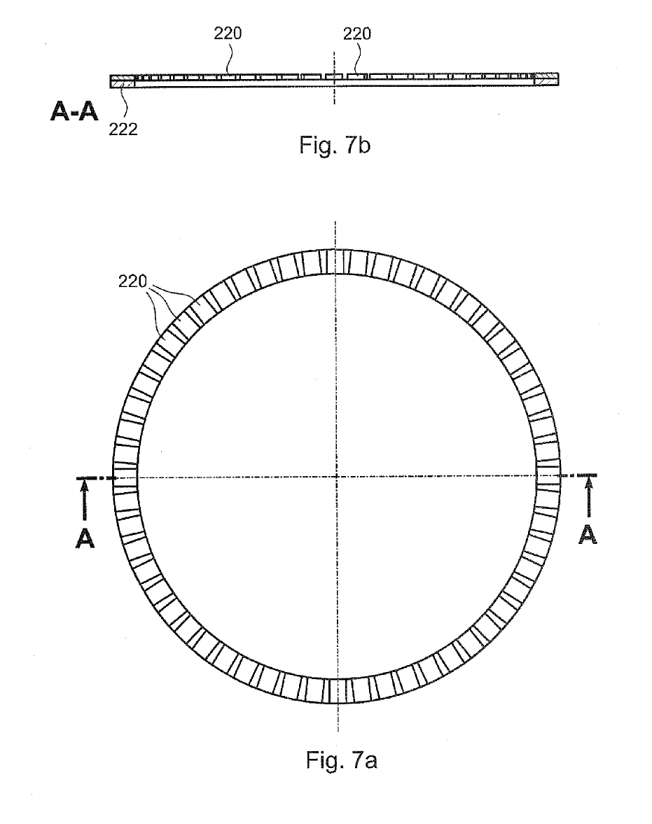

In the embodiment considered here, the rotor of the axial flow motor is formed by a permanent magnetic material; here it is in the form of individual permanent magnets 220 arranged on a ring 222 (cf. FIG. 7).

The permanent magnets 220 are magnetized in the axial direction, so that the magnetic flux between the ends 224 of stator teeth 214 and the permanent magnets 220 across an air gap between the ends 224 and the permanent magnets 220 also extends in the axial direction of wet rotor pump 200. For this reason, magnetic attraction is exerted from stator 210 to permanent magnets 220, and thus to an impeller 226 of wet rotor pump 200.

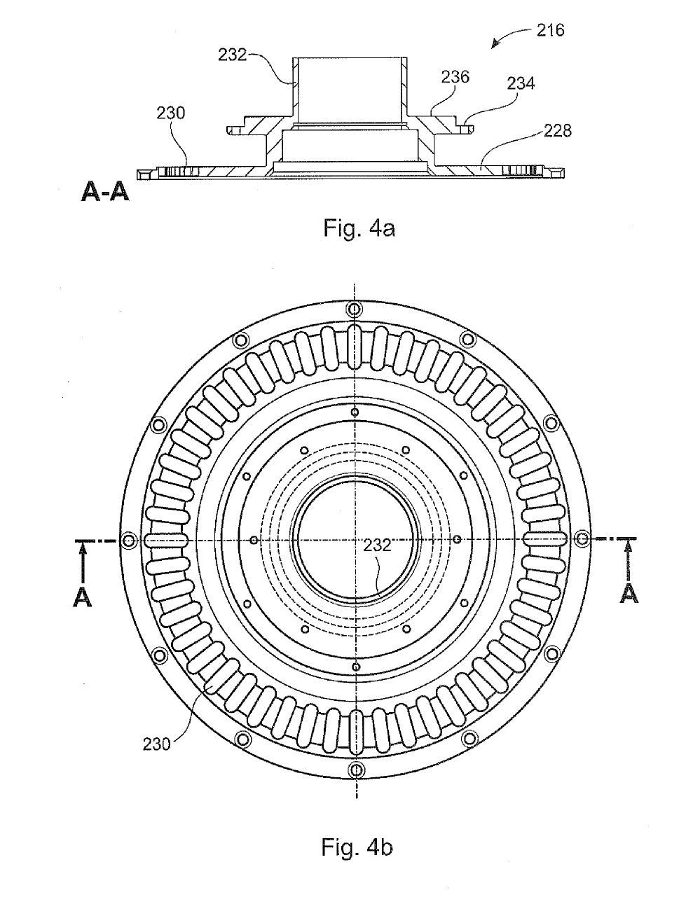

A disc 228 of a separating can 216 projects into the air gap between the ends 224 of stator teeth 214 and permanent magnets 220 (see FIGS. 4a, b).

Separating can 216 and stator 210 delimit a space in which the power electronics can be arranged, for example, on a ring-shaped circuit board whose outer radius is delimited by recesses 230 and whose inner radius is delimited by the wall of intake neck 232. This circuit board can hold the various electrical and electronic components to realize the power electronics. Since this circuit board is arranged in the dry area of wet rotor pump 200, special encapsulation of the power electronics is not absolutely necessary.

The wet rotor pump 200 has a first housing half 238 and a second housing half 240 that form the housing of the wet rotor pump 200. Housing half 238 has an opening in its center. Separating can 216 is fastened to the outside of housing half 238, for example by threaded connections on a ring-shaped fastening area 242 of housing half 238.

Impeller 226 is located between housing halves 238 and 240. On impeller 226, the rotor is formed by connecting, for example bolting, the ring 222 holding the permanent magnets 220 together with impeller 226 through a drive wheel 244. According to an alternative embodiment, permanent magnets 220 can also be arranged directly on impeller 226. Permanent magnets 220 can also be arranged between ring 222 and drive wheel 244.

Impeller 226 is mounted in the wet rotor pump by a combination of sliding bearings and rolling bearings. In the embodiment shown here, the rolling bearing is in the form of a ball bearing. However, it is also conceivable for other variants of rolling bearings, such as, for example, roller bearings, cone bearings, needle bearings, or similar ones to be used.

The rolling bearing is formed by two bearing shells 252 and 250 that have running surfaces to hold rolling bodies 254. In this arrangement, the lower bearing shell 250 is fastened to impeller 226, while the upper bearing shell 252 is fastened to the separating can. The bearing shells can be, for example, adhesively bonded, shrunk or pressed, or bolted onto the corresponding components. The rolling bodies are located in the space between the bearing shells that is delimited by the running surfaces of the bearing shells. If operation of the pump is expected to involve high rotational speeds of the impeller, the rolling bodies can be connected together by a cage, to increase the stability of the bearing.

The sliding bearing is formed by an upper sliding bearing surface 256 between the upper bearing shell 252 and the lateral surface of the impeller 226, and by a lower sliding bearing surface 258 between the lower bearing shell 250 and the separating can 216. Especially on bearing surface 256, the sliding bearing has a little bearing clearance, which allows part of the fluid 208 to get into the rolling bearing. Penetration of the conveyed fluid into the rolling bearing can additionally lubricate the rolling bearing.

The bearing clearance, which can be considered a ring-shaped opening, is preferably protected by a fine wire filter 260, to keep foreign bodies that can be contained in the conveyed fluid away from the bearing area. Fine wire filter 260 is locked in place by a clamping ring 262.

Manufacturing with appropriate exactness can keep the bearing clearance on the sliding bearings very small, preferably in the range below 0.1 mm. This will prevent coarse particles that might be contained in fluid 208 from getting into the rolling bearing and damaging the running surfaces of the bearing shells or the rolling bodies. In addition, this narrow hydrodynamic gap serves as a sealing surface between the pump's suction and pressure sides, which makes it possible to avoid leakage effects that usually occur if the impeller is fastened in the classic manner on a shaft and is not mounted on the suction side.

To increase the bearing's durability even more, it is possible to coat the running surfaces of bearing shells 250 and 252 and/or the rolling bodies 254 and/or the sliding bearing surfaces 256 and 258 with SiC, DLC, or silicon-containing DLC. Ceramic or plastic bearings are also conceivable alternatives; they have low friction in aqueous media and can be used without danger of corrosion.

The previously described bearing supports impeller 226 with an axial degree of freedom, since permanent magnets 220 exert a magnetic attraction on impeller 226 in the axial direction toward stator 210, so that the axial position of impeller 226 is also determined. Here the bearing is designed in such a way that it counters the magnetic attraction on one side in the axial direction.

During rotation, the magnetic attraction of stator 210 also has a self-centering effect on impeller 226, which reduces the stress on the radial sliding bearing.

The two housing halves 238 and 240 are connected together by bolts or adhesive 242.

This forms an outlet 246 for fluid 208.

Embodiments of the disclosure are especially advantageous since the fluid 208 flows in on the stator side, and does so through the stator. The axial flow in the motor also means that the impeller only needs to be mounted on one side, without any rotor shaft, which allows an especially compact overall design with high power density.

FIG. 4a shows a sectional view of separating can 216. Separating can 216 has a disc 228 that projects into the air gap between the ends 224 of stator teeth 214 and permanent magnets 220. The disc 228 has recesses 230 that serve to hold the ends of the stator teeth 214 (cf. FIG. 4b). The supports lying between the recesses increase the mechanical stability of the motor construction and allow the material to be as thin as possible, thus minimizing the air gap. For example, the wall thickness of separating can 216 in the recesses 230 is between 0.7 mm and 0.2 mm. Such a thin wall reduces the air gap, which in turn increases the efficiency and power, while using the same number of rare earth magnets. This improves the mechanical stability of the motor construction.

Disc 228 has an axial opening that has an intake neck 232 arranged on it.

When the wet rotor pump 200 is assembled (cf. FIG. 3), intake neck 232 projects through stator 210 and opening 206 of motor cover 202, so that the fluid 208 can flow in through intake neck 232.

Intake neck 232 has two fastening areas 234 and 236 arranged at an axial distance from disc 228. Fastening area 14 has motor cover 202 fastened to it by threaded connections, for example. Stator 210 is fastened, for example by threaded connections, in fastening area 234 between motor cover 202 and disc 228, the ends 224 of stator teeth 214 standing in recesses 230 and being held there, e.g., in a form-fit manner.

Fastening areas 234 and 236 can be ring-shaped, for example, and have internal threads to form threaded connections to fasten motor cover 202 and stator 210, which have corresponding through holes for bolts. Simultaneously, the tubular extension of the separating can that is disc-shaped and extends upward also serves to center the stator grounding ring, i.e., stator tooth holder 212

FIG. 4b shows a top view of separating can 216, through whose intake neck the fluid can flow in.

FIG. 5a shows a front view of a stator tooth 224 in accordance with the embodiment shown in FIG. 3. The holding area 218 of stator tooth 224 serves to hold several windings of a coil that is controlled by the circuit board's power electronics.

The holding area 218 of stator tooth 214 on the air gap-side is closed by the end 224 of stator tooth 214; the end 224 has a larger cross section than holding area 218. This larger cross section has the advantage that the magnetic field in the air gap is correspondingly broadened and is approximately homogeneous in a larger spatial area. This supports the self-centering of impeller 226 (cf. FIG. 3), since the rotor's permanent magnets 220 are narrower in the radial direction than the width of the stator flux.

FIG. 5a shows an example of a permanent magnet 220 as it is arranged on the impeller relative to stator tooth 214. In the radial direction, permanent magnet 220 is shorter than the extension of the end 224 of stator tooth 214 in the radial direction, so that the stator tooth projects beyond permanent magnet 220. For example, permanent magnet 220 is positioned in the middle below holding area 218.

Stator tooth 214 has, in its upper area, a slot-shaped recess 248 that serves to fasten the stator tooth 214 to the stator tooth holder 212 (cf. FIG. 6).

FIG. 5b shows the stator tooth 214 in a front view and FIG. 5c shows it in a perspective view.

FIG. 6a shows a top view of stator 210 with the ring-shaped stator tooth holder 212, which has an opening in its center through which intake neck 232 runs (cf. FIG. 3). Stator teeth 214 are fastened around the periphery of stator tooth holder 212 by means of their recesses 248. This can be done by the recess 248 and/or the stator tooth holder 212 serving as adherends to bond the stator tooth 214 with its recess 248 to the edge of stator tooth holder 212. FIG. 6b shows a corresponding sectional view.

FIG. 7a shows a top view of the rotor with permanent magnets 220 arranged on ring 222. It is preferable for permanent magnets 220 to consist of samarium-cobalt, which has various advantages:
Samarium-cobalt can be used at relatively high temperatures, without suffering from remanence; in particular, fluid 208 can have a temperature of up to 200° C.
Samarium-cobalt has excellent corrosion properties, so it can be exposed to fluid 208 without a coating or encapsulation.
Since encapsulation of permanent magnets 220 is unnecessary, they can be positioned at a maximum distance from the axis of rotation, giving maximum torque and maximum motor power for a given amount of magnetic material.

Alternatively, other materials can also be used for the permanent magnets 220, such as neodymium-iron-boron, for example.

FIG. 7b shows a sectional view of the rotor consisting of ring 222 and permanent magnets 220.

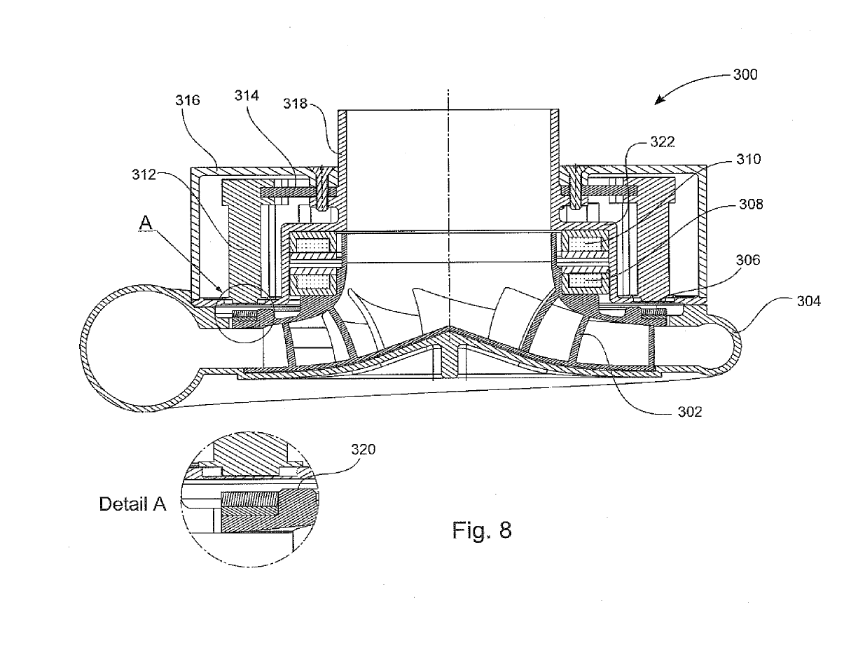

FIG. 8 shows another embodiment of an inventive wet rotor pump 300. The essential differences of wet rotor pump 300 from the wet rotor pump 200 shown in FIG. 3 are that the housing 304 and the motor cover 316 have different geometry and different dimensions. This is due to the fact that the rotor magnets 306 are now no longer fastened to a drive wheel 244, but rather directly to the impeller 302. Since the distance between the lower end of the stator teeth 312 and the rotor magnets is still as small as possible, stator teeth 312 are longer in the vertical direction. A consequence of this is that separating can 322 with suction neck 318 has a different shape. Stator tooth holder 314 has not changed with respect to stator tooth holder 212 of wet rotor pump 200.

Another difference of wet rotor pump 300 from the previously described wet rotor pump 200 is the mounting of impeller 302 in separating can 322. Instead of a rolling bearing, consisting of bearing shells 250 and 252, and rolling bodies 254, the impeller 302 of wet rotor pump 300 is axially supported by two magnetic rings that are magnetized in such a way that they repel one another in the axial direction when mounted. A lower magnetic ring 308 is fastened to impeller 302, while an upper magnetic ring 310 is fastened to the separating can. The magnetic rings can be fastened to bearing shells 250 and 252 of wet rotor pump 200 in an analogous manner by adhesive bonding, bolting, shrinking, pressing, or another fastening method.

Magnetic rings 308 and 310 consist of permanent magnets such as, for example, neodymium-iron-boron (NdFeB) or samarium-cobalt (SmCo), and are encapsulated in metal to make them completely air- and watertight. This encapsulation can be done by laser or friction welding of the encapsulation components, for example. A preferred embodiment of the encapsulation components is that the all non-facing sides consist of a non-magnetic metal, such as, for example, stainless steel, while the welded-on cover plate, that is the two facing sides, consist of soft magnetic material. This intensifies the magnetic flux in the area of the cover plates.

The thickness of the encapsulation can be between 1 mm and 2 mm, for example. The magnetic ring 308 pressed on the impeller-side is, analogous to the lower bearing shell 250 of the wet rotor pump 200, made in such a way that it forms, between the outer lateral surface of the magnetic ring 308 and the inner lateral surface of separating can 322, a hydrodynamic gap that also functions as a sealing gap.

Magnetic rings 308 and 310 are preferably magnetized and oriented in such a way that the repellent force between the magnetic rings is approximately [inversely] proportional to the square of the distance between the magnetic rings. It is preferable for the strength of magnetic rings 308 and 310 to be dimensioned in such a way that when wet rotor pump 300 is idle the attractive force between rotor magnets 306 and stator teeth 312 and the repulsive force between magnetic rings 308 and 310 are in equilibrium. This preferably produces an idle air gap between the lower end of stator teeth 312 and rotor magnets 306 of about 1 mm, while that between the magnetic rings 308 and 310 is about 3 mm. Thus, the magnetic field strength produced by magnetic rings 308 and 310 is dimensioned to be stronger than that between rotor magnets 306 and stator teeth 312.

As the rotational speed, and thus power, of the wet rotor pump 300 increases, there is an increase in the pressure difference between the suction and pressure side of wet rotor pump 300, and thus in the contact pressure of impeller 302 upward, in the direction toward suction neck 318. In an analogous manner, there is also an increase in the contact pressure on the repellent magnetic rings 308 and 310, so that both the air gap between magnetic rings 308 and 310 and the air gap between the rotor magnets 306 and the stator teeth 312 is reduced. This reduction in the air gap continues until the contact pressure, attractive force between rotor magnets 306 and stator teeth 312, and repulsive force between magnetic rings 308 and 310 reach a new equilibrium.

To prevent the rotor setting down onto static components of wet rotor pump 300, the power limit of the wet rotor pump can be dimensioned in such a way that the air gap between rotor magnets 306 and stator teeth 312 does not fall below 0.2 mm. In addition, the rotor can have safety sliding surfaces 320 on it that project, for example, 0.2 mm upward beyond rotor magnets 306. If the previously mentioned power limit is exceeded, these safety sliding surfaces 320 can support the rotor on the separating can 322 and prevent damage to the impeller 302 or rotor magnets 306.

As the pressure output increases, the reduction in the air gap between rotor magnets 306 and stator teeth 312 increases the coupling between rotor magnets 306 and stator teeth 312 because of the increasing magnetic flux density. This effectively leads to an increase in output and thus to increased efficiency of wet rotor pump 300.

Some aspects and features of the disclosed embodiments are set out in the following numbered items:

1. Device (100; 200) having a first (102; 226) and a second component (104; 216), wherein the second component includes an opening (106), wherein the first component is mounted such that the first component can rotate in the radial direction and on one side in the axial direction in the opening of the second component about an axis (108; 208) of the first component, wherein the device is formed in such a manner that a fluid can flow in the axial direction through the opening in the second component, wherein the device also comprises at least two bearing shells (110,112; 250, 252), and rolling bodies (114; 254), wherein a first of the bearing shells (110; 250) is axially supported on the first component and a second of the bearing shells (112; 252) is axially supported on the second component, wherein the rolling bodies are situated in the space delimited by the running faces of the two bearing shells, as a result of which a rolling bearing that can be loaded in the axial direction on one side is formed for axially bearing the first component in the second component, characterized in that a sliding bearing (116; 258) for radially bearing the first component on the second component is formed by a surface of the first component, especially a cylindrical surface, and an inner lateral surface of the second bearing shell and/or by a surface, especially a cylindrical surface, of the opening in the second component and an outer lateral surface of the first bearing shell.
2. The device described in item 1, wherein the first and/or second bearing shell (110, 112; 250, 252) is fastened to the first or second component (102, 104; 226, 216).
3. The device described in item 1, wherein the sliding bearing (116; 258) is formed on exactly one bearing shell (110, 112; 250, 252) and the other bearing shell can be radially displaced in a [hole] that is radially oversized with respect to the axially supporting component (102, 104; 226, 216), to follow an off-center operating position of the sliding bearing (116; 258), thereby maintaining the coaxial orientation of the bearing shells to one another.
4. The device described in item 3, wherein the bearing shells (110, 112; 250, 252) together with the rolling bodies (114; 254) form a radially not adjustable thrust bearing, especially a thrust ball bearing, a tapered roller bearing or a conical thrust needle bearing.
5. The device described in item 1, wherein the bearing shells together with the rolling bodies form a radially adjustable thrust bearing, especially a flat thrust needle bearing or a flat thrust roller bearing.
6. The device described in items 1 or 3, also having a particle filter (124; 260), that is arranged on a side of the bearing shell facing away from the running surfaces of the rolling bearing, especially one in the form of a fine wire filter.
7. The device described in one of the preceding items, wherein the running surfaces and/or lateral surfaces (116; 258) of the bearing shells and/or the rolling bodies are coated with silicon carbide (SiC) and/or diamond-like carbon (DLC) and/or silicon-containing DLC.
8. Device (300) having a first (322) and a second (302) component, wherein the second component includes an opening, wherein the first component is mounted such that the first component can rotate in the radial direction and on one side in the axial direction in the opening of the second component about an axis of the first component, wherein the device is formed in such a manner that a fluid can flow in the axial direction through the opening of the second component, wherein the device also comprises at least two magnetic rings (308, 310) wherein a first of the magnetic rings is axially supported on the first component and a second of the magnetic rings is axially supported on the second component, wherein the magnetization of the magnetic rings is arranged so that they repel one another in the axial direction, forming a magnetic bearing that can be loaded on one side in the axial direction for axially bearing the first component in the second component, characterized in that a sliding bearing for radially bearing the first component on the second component is formed by a surface of the first component, especially a cylindrical surface, and an inner lateral surface of the second bearing shell and/or by a surface, especially a cylindrical surface, of the opening in the second component and an outer lateral surface of the first magnetic ring.
9. The device described in item 8, wherein the first and/or second magnetic ring (308, 310) is fastened to the first or second component (322, 302).
10. The device described in item 8, with a particle filter, wherein the particle filter is arranged on a side of the magnetic rings facing away from the inside of the bearing, especially one in the form of a fine wire filter.
11. The device described in one of items 8 and 9, wherein the lateral surfaces of the magnetic rings are coated with silicon carbide (SiC) and/or diamond-like carbon (DLC) and/or silicon-containing DLC.
12. The device described in one of the preceding items, wherein the radial bearing clearance is adapted in such a way that the sliding bearing is a fluid bearing.
13. The device described in one of items 1 through 12 in an embodiment as a turbine, wherein the first component is an arrangement of blade wheels.
14. The device described in one of items 1 through 12 in an embodiment as a machine tool, wherein the first component is a spindle.
15. The device described in one of items 1 through 12 in an embodiment as a dental turbine, wherein the first component is an arrangement of blade wheels and wherein the fluid is air.
16. The device described in one of items 1 through 12 in an embodiment as a wet rotor pump (200; 300), wherein the first component is an impeller (226; 302) lying in the wet area and the second component is a separating can (216; 322) lying in the dry area, wherein the separating can (216) has a stator (210) arranged on it that forms, together with a rotor (220, 322) arranged on the impeller, the magnetic part of an axial flow motor, wherein an intake pipe (232; 318) for a fluid (208) to be conveyed by the impeller runs through the separating can and stator in the axial direction, and wherein the rolling or magnetic bearing that can be loaded on one side in the axial direction is axially arranged around one end of the intake neck and is designed to support the magnetic attraction that the stator (210) exerts on the rotor (220; 306) in operation.
17. The wet rotor pump (200; 300) described in item 16, wherein the intake neck is formed by at least an intake neck (232) formed on the separating can (216) and by the bearing.
18. The wet rotor pump (200) described in item 17, wherein the separating can has a disc (228) that projects into the air gap of the axial flow motor, and the separating can (216) is made as a single piece, especially as a molded part.
19. The wet rotor pump (200; 300) described in one of the preceding items 16 through 18, wherein the stator (210) is formed by a ring-shaped stator tooth holder (212) that has stator teeth (214) fastened around its periphery.
20. The wet rotor pump (200; 300) described in item 19, wherein the stator tooth holder (212) and the stator teeth are adhesively bonded.
21. The wet rotor pump (200) described in item 18 or 19, wherein each of the stator teeth (214) has a coil holding area (218) running in the axial direction, wherein the holding area is limited by an air gap-side end (224) of the stator tooth in question, wherein the air gap-side end of the stator tooth has a face that is larger than the cross section of the holding area.
22. The wet rotor pump (200; 300) described in one of the preceding items 16 through 21, with power electronics to control the stator (210), wherein the power electronics are arranged inside the space delimited between the stator and the separating can (216).
23. The wet rotor pump (200) described in one of 15 through 26, wherein the separating can (216) has a disc (228) that projects into the air gap, wherein the disc has a central opening that has an intake neck (232) formed on it to let in the fluid, wherein an end area of the intake neck holds part of the bearing.
24. The wet rotor pump (200; 300) described in item 23, wherein the disc has recesses (230) along its periphery to hold the air gap-side ends of the stator teeth.
25. The wet rotor pump (200; 300) described in one of the preceding items 16 through 24, wherein the rotor comprises samarium-cobalt (SmCo).
26. The wet rotor pump (200; 300) described in one of the preceding items 16 through 25, wherein the rotor is formed by several permanent magnets (220; 306) arranged on the periphery of the impeller or by a magnetic ring with multipolar magnetization.
27. The wet rotor pump (200; 300) described in one of the preceding items 16 through 26, wherein the bearing forms a seal.
28. The wet rotor pump (200) described in one of the preceding items 16 through 27, wherein the permanent magnets (220) are shorter in the radial direction than the ends (224) of the stator teeth (214).

### LIST OF REFERENCE NUMBERS

100 Device
102 First component
104 Second component
106 Opening
108 Axis
110 First bearing shell
112 Second bearing shell
114 Rolling body
116 Sliding bearing surface
118 Transmission element
120 Gap
122 Flow direction
124 Filter element
126 Clamping ring
128 Recess
200 Wet rotor pump
202 Motor cover
204 Face
206 Opening
208 Fluid
210 Stator
212 Stator tooth holder
214 Stator tooth
216 Separating can
218 Holding area
220 Permanent magnet
222 Ring
224 End
226 Impeller
228 Disc
230 Recess
232 Intake neck
234 Fastening area
236 Fastening area
238 Housing half
240 Housing half
242 Fastening area
244 Drive wheel
246 Outlet
248 Recess
250 Lower bearing shell
252 Upper bearing shell
254 Rolling body
256 Upper sliding bearing surface
258 Lower sliding bearing surface
260 Fine wire filter
262 Clamping ring
300 Wet rotor pump
302 Impeller
304 Pump housing
306 Rotor magnets
308 Lower magnetic ring
310 Upper magnetic ring
312 Stator tooth
314 Stator tooth holder
316 Motor cover
318 Suction neck
320 Safety sliding surface
322 Separating can

What is claimed is:

1. A device having a first and a second component, wherein the second component includes an opening, wherein the first component is mounted such that the first component can rotate in the radial direction and on one side in the axial direction in the opening of the second component about an axis of the first component, wherein the device is formed in such a manner that a fluid can flow in the axial direction through the opening in the second component, wherein the device also comprises at least two bearing shells, and rolling bodies, wherein a first of the bearing shells is axially supported on the first component and a second of the bearing shells is axially supported on the second component, wherein the rolling bodies are situated in the space delimited by the running faces of the two bearing shells, as a result of which a rolling bearing that can be loaded in the axial direction on one side is formed for axially bearing the first component in the second component, characterized in that a sliding bearing for radially bearing the first component on the second component is formed by a surface of the first component, especially a cylindrical surface, and an inner lateral surface of the second bearing shell and/or by a surface, especially a cylindrical surface, of the opening in the second component and an outer lateral surface of the first bearing shell.

2. The device described in claim 1, wherein the first and/or second bearing shell is fastened to the first or second component.

3. The device described in claim 1, wherein the sliding bearing is formed on exactly one bearing shell and the other bearing shell can be radially displaced in a [hole] that is radially oversized with respect to the axially supporting component, to follow an off-center operating position of the sliding bearing, thereby maintaining the coaxial orientation of the bearing shells to one another.

4. The device described in claim 3, wherein the bearing shells together with the rolling bodies form a radially not adjustable thrust bearing, especially a thrust ball bearing, a tapered roller bearing or a conical thrust needle bearing.

5. The device described in claim 1, wherein the bearing shells together with the rolling bodies form a radially adjustable thrust bearing, especially a flat thrust needle bearing or a flat thrust roller bearing.

6. The device described in claim 1, also having a particle filter, that is arranged on a side of the bearing shell facing away from the running surfaces of the rolling bearing, especially one in the form of a fine wire filter.

7. The device described in claim 1, wherein the running surfaces and/or lateral surfaces of the bearing shells and/or the rolling bodies are coated with silicon carbide (SiC) and/or diamond-like carbon (DLC) and/or silicon-containing DLC.

8. A device having a first and a second component, wherein the second component includes an opening, wherein the first component is mounted such that the first component can rotate in the radial direction and on one side in the axial direction in the opening of the second component about an axis of the first component, wherein the device is formed in such a manner that a fluid can flow in the axial direction through the opening of the second component, wherein the device also comprises at least two magnetic rings wherein a first of the magnetic rings is axially supported on the first component and a second of the magnetic rings is axially supported on the second component, wherein the magnetization of the magnetic rings is arranged so that they repel one another in the axial direction, forming a magnetic bearing that can be loaded on one side in the axial direction for axially bearing the first component in the second component, characterized in that a sliding bearing for radially bearing the first component on the second component is formed by a surface of the first component, especially a cylindrical surface, and an inner lateral surface of the second bearing shell and/or by a surface, especially a cylindrical surface, of the opening in the second component and an outer lateral surface of the first magnetic ring.

9. The device described in claim 8, wherein the first and/or second magnetic ring is fastened to the first or second component.

10. The device described in claim 8, with a particle filter, wherein the particle filter is arranged on a side of the magnetic rings facing away from the inside of the bearing, especially one in the form of a fine wire filter.

11. The device described in claim 8, wherein the lateral surfaces of the magnetic rings are coated with silicon carbide (SiC) and/or diamond-like carbon (DLC) and/or silicon-containing DLC.

12. The device described in claim 1, wherein the radial bearing clearance is adapted in such a way that the sliding bearing is a fluid bearing.

13. The device described in claim 1 in an embodiment as a turbine, wherein the first component is an arrangement of blade wheels.

14. The device described in claim 1 in an embodiment as a machine tool, wherein the first component is a spindle.

15. The device described in claim 1 in an embodiment as a dental turbine, wherein the first component is an arrangement of blade wheels and wherein the fluid is air.

16. The device described in claim 1 in an embodiment as a wet rotor pump, wherein the first component is an impeller lying in the wet area and the second component is a separating can lying in the dry area, wherein the separating can has a stator arranged on it that forms, together with a rotor arranged on the impeller, the magnetic part of an axial flow motor, wherein an intake pipe for a fluid to be conveyed by the impeller runs through the separating can and stator in the axial direction, and wherein the rolling or magnetic bearing that can be loaded on one side in the axial direction is axially arranged around one end of the intake neck and is designed to support the magnetic attraction that the stator exerts on the rotor in operation.

17. The wet rotor pump described in claim 16, wherein the intake neck is formed by at least an intake neck formed on the separating can and by the bearing.

18. The wet rotor pump described in claim 17, wherein the separating can has a disc that projects into the air gap of the axial flow motor, and the separating can is made as a single piece, especially as a molded part.

19. The wet rotor pump described in claim 16, wherein the stator is formed by a ring-shaped stator tooth holder that has stator teeth fastened around its periphery.

20. The wet rotor pump described in claim 19, wherein the stator tooth holder and the stator teeth are adhesively bonded.

21. (canceled)

22. (canceled)

23. (canceled)

24. (canceled)

25. (canceled)

26. (canceled)

27. (canceled)

28. (canceled)
